(19) United States
(12) Patent Application Publication
(10) Pub. No.: US 2022/0062669 A1
(43) Pub. Date: Mar. 3, 2022

(54) MASK PPE WITH MULTIPLE ADHESIVE LOCATIONS FOR SECURING TO THE FACE

(71) Applicant: Prolificare LLC, Ventura, CA (US)

(72) Inventors: Jed Brian WOCKENFUSS, Glendale, CA (US); Peter STRAUSS, Costa Mesa, CA (US); Adriana Martin Harrison, Rancho Palos Verdes, CA (US)

(21) Appl. No.: 17/003,643

(22) Filed: Aug. 26, 2020

(51) Int. Cl. A62B 18/02; A41D 13/11; A62B 18/08

(52) U.S. Cl. CPC A62B 18/025; A62B 18/084; A41D 13/1169

(57) ABSTRACT

Embodiments of the present invention are drawn to mask personal protective equipment (PPE) with multiple adhesive portions that secure the mask around the nose and mouth of the wearer. In one exemplary embodiment, an air-permeable layer is configured to cover a nose and mouth of a wearer, a first adhesive layer is disposed on a first lateral edge portion of the air-permeable layer, and a second adhesive layer is disposed on a second lateral edge portion of the air-permeable layer to secures the air-permeable layer to the face of the wearer. The mask can also include ear loops or other fasteners that can work in conjunction with the adhesive portions, and the fasteners can be removed after the adhesive portions are applied to the wearer's face for added freedom.

### FIELD

Embodiments of the present invention generally relate to the field personal protective equipment (PPE). More specifically, embodiments of the present invention relate to mask PPE for protection against the transmission of viruses and other germs.

### BACKGROUND

Current approaches to mask PPE typically involve face masks, face shields, etc., that are designed to prevent the spread of germs and viruses to others and/or to prevent the exposure of the wearer to the same. In a medical environment, mask PPE is frequently worn by doctors, nurses, technicians, and other healthcare personnel that are present in a treatment room or operating room, for example. Mask PPE may also be worn in hazardous environments to protect the wearer from exposure to toxic gases or highly polluted air, for example.

Recently mask PPE use has become common in every-day life for the protection of the wearer against airborne viruses, and to prevent the spread of airborne viruses by infected individuals. In some areas, face PPE is required for entry into stores, schools, airports, etc. For effective every-day use, mask PPE should be comfortable and should be securely attached to the face e.g., around the nose and mouth, so that it can effectively protect the wearer and prevent the spread of disease during every-day activities, such as visiting a store, school, airport, etc. To this end, some masks include a thin strip of deformable metal at the top edge of the mask designed to bend and form to the wearer's nose. The flexible metal strip can provide a more comfortable fit that helps secure the mask PPE to the wear's face around the nose and mouth area. However, because the thin metal strip only helps to secure the top edge of the mask around the wearer's nose, the sides of the mask tend to fit loosely near the mouth, thereby allowing air to flow in and out of gaps between the mask and the wearer's face.

FIG. 1 depicts an exemplary prior art mask PPE 100 that suffers from these deficiencies. As depicted in FIG. 1, air that is exhaled by the wearer flows outward through gaps 105 and 110 on each lateral edge of the mask. The prior art mask PPE 100 is further held in place using ear loops or straps, and despite the top edge 115 of the mask fitting relatively securely around the wearer's nose, the lateral edges of the mask bow outward creating gaps 105 and 110 that enable air e.g., exhaled breath, to flow between the mask 100 and the wearer's face. Moreover, air can enter the lateral gaps 105 and 110 in the mask 100 thereby bypassing the mask entirely, rendering the wearer vulnerable to contamination from germs and viruses.

Moreover, prior art mask PPE 100 requires ear loops to secure the mask 100 to the wearer's face, and the ear loops can obstruct access to the wearer's hair, face, and neck for instance during a haircut or other medical procedure, etc., and therefore a mask PPE that can be secured to the wearer's face without the necessary use of ear loops is desired.

Accordingly, what is needed is an approach to mask PPE that better secures the mask to the wearer's face without necessarily requiring ear loops to improve the fit and effectiveness of the mask PPE.

### SUMMARY

Embodiments of the present invention are drawn to protective masks. The mask can be a surgical mask or other protective apparatus that includes multiple adhesive strips configured to secure the lateral edge portions of the mask to the wearer's face, such as a medical grade protective mask. Mask embodiments of the present invention may or may not include the ear loops.

In one exemplary embodiment, an air-permeable layer is configured to cover a nose and mouth of a wearer, a first adhesive layer is disposed on a first lateral edge portion of the air-permeable layer, and a second adhesive layer is disposed on a second lateral edge portion of the air-permeable layer to secures the air-permeable layer to the face of the wearer. The mask can also optaionlly include ear loops or other fasteners that can help alight the mask to the face and that can also work in conjunction with the adhesive portions, and the fasteners can optionally be removed after the adhesive portions are applied to the wearer's face for added freedom.

According to some embodiments, the novel mask includes a flexible metal strip disposed on a top edge portion of said air-permeable layer configured to conform the top edge portion of said air-permeable layer to the nose of the wearer.

According to some embodiments, the mask includes removeable or non-removeable ear loops.

According to some embodiments, the mask includes a third adhesive layer disposed below said first adhesive layer on said first later edge portion of the air-permeable layer, and a fourth adhesive layer disposed below said second adhesive layer on said second lateral edge portion of the air-permeable layer.

According to some embodiments, said first, second, third, and fourth adhesive layers include adhesive strips substantially ½ inch in length and ¼ inch in width, of course any other suitable length can be used.

According to some embodiments, said first and second adhesive layers are respectively disposed on center portions of said first and second lateral edge portions.

According to some embodiments, said first and second adhesive layers comprise adhesive strips substantially 2 inches in length.

According to another embodiment, a protective mask is disclosed. The protective mask includes an air-permeable layer configured to cover a nose and mouth of a wearer, a pair of straps for securing the air-permeable layer around the nose and mouth of the wearer, a first adhesive layer disposed on a first lateral edge portion of the air-permeable layer, and a second adhesive layer disposed on a second lateral edge portion of the air-permeable layer, where the first and second adhesive layers secure the air-permeable layer around the nose and mouth of the wearer in conjunction with the pair of straps to substantially prevent breath from flowing out of lateral gaps between said air-permeable layer and the nose and mouth of the wearer.

According to another embodiment, a mask personal protective equipment is disclosed an includes an air-permeable layer configured to cover a nose and mouth of a wearer, a pair of removeable straps for securing the air-permeable layer around the nose and mouth of the wearer, a first adhesive layer disposed on a first lateral edge portion of the air-permeable layer, and a second adhesive layer disposed on a second lateral edge portion of the air-permeable layer, where the first and second adhesive layers secure the air-permeable layer around the nose and mouth of the wearer and the pair of removeable straps are operable to be removed after the first and second adhesive layers are applied to the wearer.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a diagram depicting an exemplary prior art mask PPE with ear loops.

FIG. 2A is a diagram of a rear view of an exemplary mask PPE with multiple adhesive strips according to embodiments of the present invention.

FIG. 2B is a diagram of a front view of an exemplary mask PPE with multiple adhesive strips according to embodiments of the present invention.

FIG. 3A is a diagram of a rear view of an exemplary mask PPE with four adhesive strips according to embodiments of the present invention.

FIG. 3B is a diagram of a front view of an exemplary mask PPE with four adhesive strips according to embodiments of the present invention.

FIG. 4 is a diagram of an exemplary mask PPE with multiple adhesive strips covering a wearer's face according to embodiments of the present invention.

FIG. 5A is a diagram of a rear view of an exemplary mask PPE with multiple adhesive strips and without ear loops according to embodiments of the present invention.

FIG. 5B is a diagram of a front view of an exemplary mask PPE with multiple adhesive strips and without ear loops according to embodiments of the present invention.

FIG. 6A is a diagram of a rear view of an exemplary mask PPE with four adhesive strips and without ear loops according to embodiments of the present invention.

FIG. 6B is a diagram of a rear view of an exemplary mask PPE with four adhesive strips and without ear loops according to embodiments of the present invention.

FIG. 7 is a diagram of an exemplary mask PPE with multiple adhesive strips covering a wearer's face without using ear loops according to embodiments of the present invention.

FIG. 8 is a flow chart of an exemplary sequence of computer implemented steps for using a mask with multiple adhesive strips for securing the mask to the face according to embodiments of the present invention.

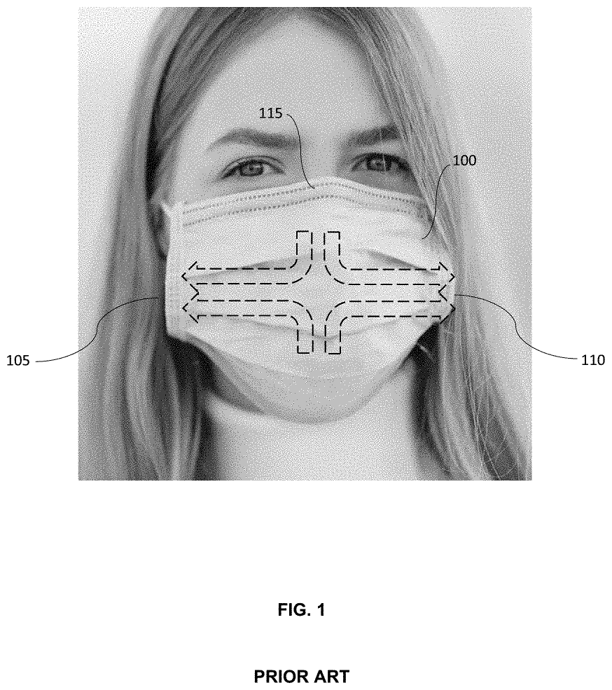

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

### Mask PPE with Multiple Adhesive Locations and Ear Loops

Embodiments of the present invention are drawn to a protective mask. The following discussion describes one such exemplary protective mask. The mask can include an air-permeable, multi-layer polymer layer, such as polypropylene, in combination with and outer layer of non-woven fabric. The air-permeable layer can include pleats that can be stretched/expanded during use. The air-permeable layer is configured to block or filter airborne particles, droplets, etc., to prevent the transmission of viruses and other germs.

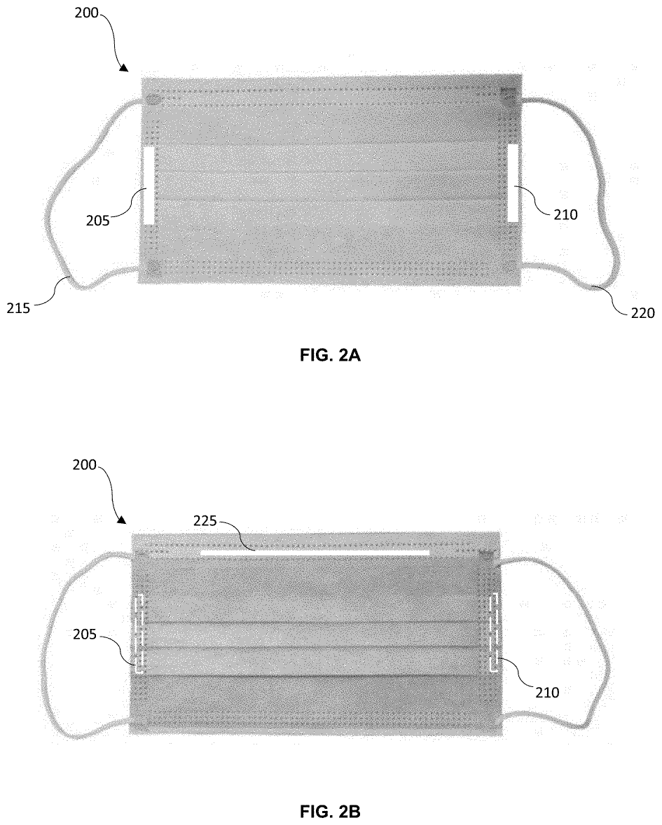

With regard to FIG. 2A, a rear view of an exemplary mask PPE 200 with multiple adhesive strips is depicted according to embodiments of the present invention. Adhesive strips 205 and 210 secure the lateral edge portions of the mask 200 to the wearer's face around the nose and mouth to improve the effectiveness of the mask for preventing transmission of viruses and other germs, and to secure mask 200 to the wearer's face with or without the use of ear loops or other lightweight fasteners. The mask in made from an air-permeable multi-layer material or other breathable material configured to be placed over a mouth and nose of the wearer. Adhesive strips 205 and 210 can include removeable plastic cover strips that can be peeled off for protecting the adhesive before application to the user's face. The width and length dimensions of mask 200 can eb of any well-known mask dimensions.

According to some embodiments, the adhesive strips 205 and 210 are layers of double-sided adhesive. According to some embodiments, the adhesive strips 205 and 210 are ¼ inch×½ inch adhesive layers but could be of any suitable length. According to various embodiments, the mask 200 can also include ear loops or other fasteners that can work in conjunction with the adhesive portions, or the fasteners can be removed after the adhesive portions are applied to the wearer's face via light pressure applied thereto. The adhesive strips 205 and 210 secure the mask the face to more tightly fit e.g. “seal” the mask around the nose and mouth of the wearer, and to provide a means of securing the mask to the face in the absence of ear loops or the like. The adhesive strips can also help align the mask around the nose and mouth while used in conjunction with ear loops, for example. Advantageously, the adhesive strips 205 and 210 can only be used a number of times before the adhesive can no longer secure the mask 200 to the wearer's face, forcing the wearer to replace the mask 200 with a fresh new mask, thereby reducing the use of soiled or contaminated masks.

FIG. 2B depicts a front view of mask 200 according to embodiments of the present invention. Mask 200 includes flexible metal strip 225 for conforming the top edge of the mask to the wearer's nose and face, and ear loops or straps for securing to the wearer's ears. According to some embodiments, ear loops 215 and 220 may be of a removeable fashion and may be detached after the mask 200 is properly aligned and secured to the wearer's face using adhesive strips 205 and 210. Removing the ear loops 215 and 220 can provide enhanced freedom of movement and freedom to perform different everyday activities, such as receiving a haircut, patronizing a salon, attending a medical appointment, etc. Removing the ear loops can enhance the aesthetic appeal of the mask as the mask is held closer to the face to give a more natural appearance, and the mask is less noticeable to others after the ear loops have been removed. Securing the mask closely to the face without using ear loops also helps prevent the mask from being caught or tangled by other objects, and helps prevent the mask from becoming suddenly dislodged during use. For example, the prior art mask 100 requiring ear loops to secure the mask 100 to the face can often get tangled in eyewear, such as sunglasses and eyeglasses, or face shields and other face PPE. According to some embodiments, the ear loops can be removed by tearing or cutting the ear loops with scissors or a blade.

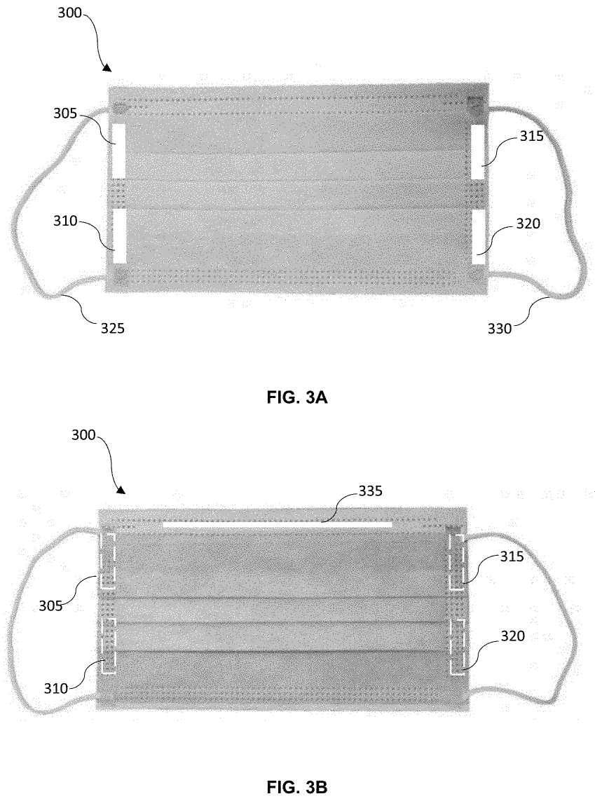

With regard to FIG. 3A, a rear view of an exemplary mask PPE 300 with multiple adhesive strips is depicted according to embodiments of the present invention. The mask is made from a well-known air-permeable multi-layer material or other material configured to be placed over a mouth and nose of the wearer. Adhesive strips 305 and 310 secure the left lateral edge portion of the mask 300 to the wearer's face, and adhesive strips 315 and 320 secure the right lateral edge of the mask 300 to the wearer's face. Adhesive strips 305 and 315 are located near the top edge of mask 300, and adhesive strips 310 and 320 are located near the bottom edge of mask 300. Securing the mask to the wearer's face in this way improves the effectiveness of the mask for preventing transmission of viruses and other germs while maintaining flexibility while talking and moving during every-day activities, and functions to secure mask 300 to the wearer's face with or without the use of ear loops or other lightweight fasteners. Adhesive strips 305, 310, 315, and 320 can include removeable plastic cover strips that can be readily peeled off for protecting the adhesive before application to the user's face.

According to some embodiments, the adhesive strips 305, 310, 315, and 320 are layers of double-sided adhesive. According to some embodiments, the adhesive strips 305, 310, 315, and 320 are ¼ inch×2 inch adhesive layers but could be of various other suitable sizes.

FIG. 3B depicts a front view of mask 300 according to embodiments of the present invention. Mask 300 includes flexible metal strip 335 for conforming the top edge of the mask to the wearer's nose and face, and ear loops or straps for securing to the wearer's ears. According to some embodiments, ear loops 325 and 330 are removeable and can be detached after the mask 300 is secured to the wearer's face using adhesive strips 305, 310, 315, and 320.

It is appreciated that the ear loops 325 and 330 can be effectively used to properly align and position the mask to the face so that the adhesive strips are properly aligned to the face. After the mask is secured to the face in this fashion, the ear loops, optionally, can be removed.

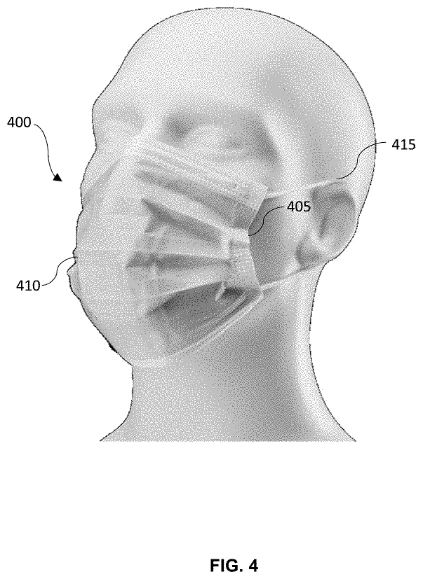

FIG. 4 depicts an exemplary mask PPE 400 secured to a wearer's face according to embodiments of the present invention. Specifically, mask 400 is secured to the wearer's face around the nose and mouth using adhesive strips on the lateral edges 405 and 410 of the mask 400 that adhere the lateral edge 405 and 410 to the wearer's face. As depicted in FIG. 4, mask 4 includes ear loops or straps 415 for optionally securing the mask to the wearer's face by looping the ear loops around the wearer's ears. According to some embodiments, the ear loops are made from elastic or similar stretchable material. According to some embodiments, the ear loops are removeable.

It is to be appreciated that once the ear loops are removed, the wearer will have increased freedom to engage in certain activities, such as receiving a haircut or style or attending to a medical visit, etc.

### Mask PPE with Multiple Adhesive Locations

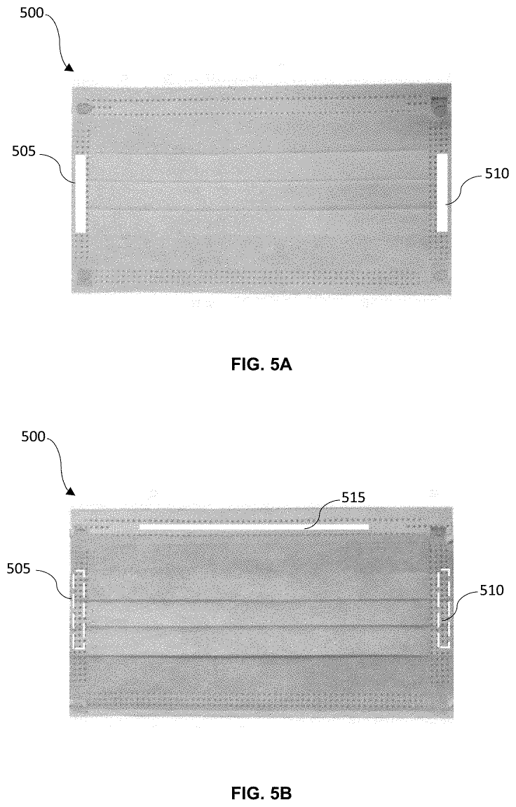

With regard to FIG. 5A, a rear view of an exemplary mask PPE 500 with multiple adhesive strips is depicted according to embodiments of the present invention. The mask in made from an air-permeable multi-layer material or other material configured to be placed over a mouth and nose of the wearer. The mask PPE 500 does not include ear loops. Adhesive strips 505 and 510 secure the lateral edges of the mask 500 to the wearer's face to improve the effectiveness of the mask for preventing transmission of viruses and other germs, and advantageously does not require the use of ear loops to secure the mask 500 to the wearer's face.

FIG. 5B depicts a front view of mask 500 according to embodiments of the present invention. Mask 500 includes flexible metal strip 515 for conforming the top edge of the mask to the wearer's nose and face. Adhesive strips 505 and 510 can include removeable plastic cover strips that can be peeled off for protecting the adhesive before application to the user's face.

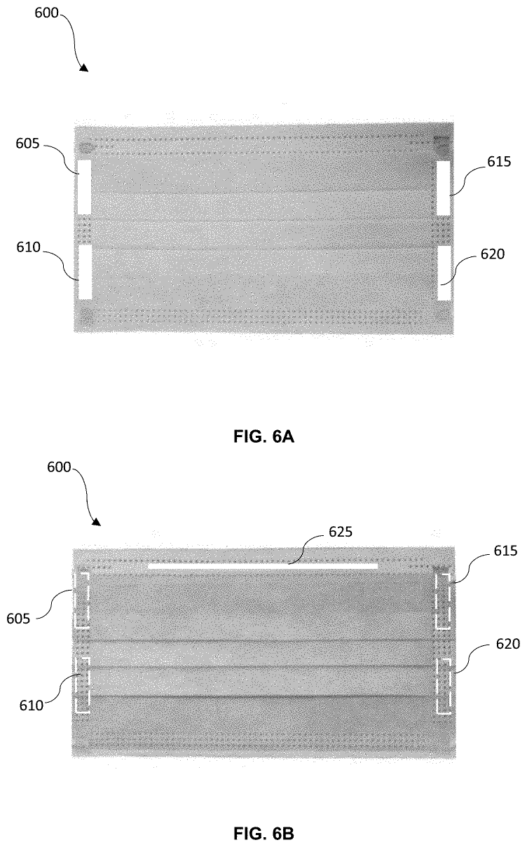

With regard to FIG. 6A, a rear view of an exemplary mask PPE 600 with multiple adhesive strips is depicted according to embodiments of the present invention. The mask is made from a well-known air-permeable multi-layer material or other material configured to be placed over a mouth and nose of the wearer. Adhesive strips 605 and 610 adhere the left lateral edge of the mask 600 to the wearer's face, and adhesive strips 615 and 620 adhere the right lateral edge of the mask 600 to the wearer's face. Adhesive strips 605 and 615 are located near the top edge of mask 600, and adhesive strips 610 and 620 are located near the bottom edge of mask 600. Securing the mask to the wearer's face in this way improves the effectiveness of the mask for preventing transmission of viruses and other germs while maintaining flexibility while talking and moving during every-day activities, and advantageously secures the mask to the wearer's face without requiring the use of ear loops.

FIG. 6B depicts a front view of mask 600 according to embodiments of the present invention. Mask 600 includes flexible metal strip 625 for conforming the top edge of the mask to the wearer's nose and face. According to some embodiments, ear loops 615 and 620 are removeable and can be detached after the mask 600 is secured to the wearer's face using adhesive strips 605, 610, 615, and 620. Adhesive strips 605, 610, 615, and 620 can include removeable plastic cover strips that can be peeled off for protecting the adhesive before application to the user's face.

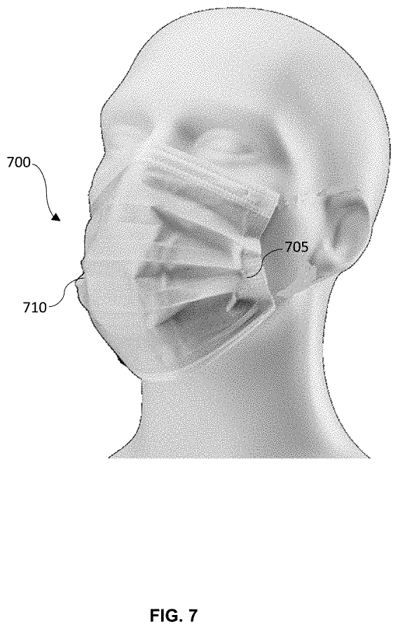

FIG. 7 depicts an exemplary mask PPE 700 secured to a wearer's face according to embodiments of the present invention. Specifically, mask 700 is secured to the wearer's face around the nose and mouth using adhesive strips on the lateral edges 705 and 710 of the mask 700 that adhere the lateral edge 705 and 710 to the wearer's face. As depicted in FIG. 7, mask 7 includes ear loops or straps 715 for optionally securing the mask to the wearer's face by looping the ear loops around the wearer's ears. As depicted in FIG. 7, mask 700 does not include ear loops, or the ear loops of the mask have been removed e.g. cut off or cut away.

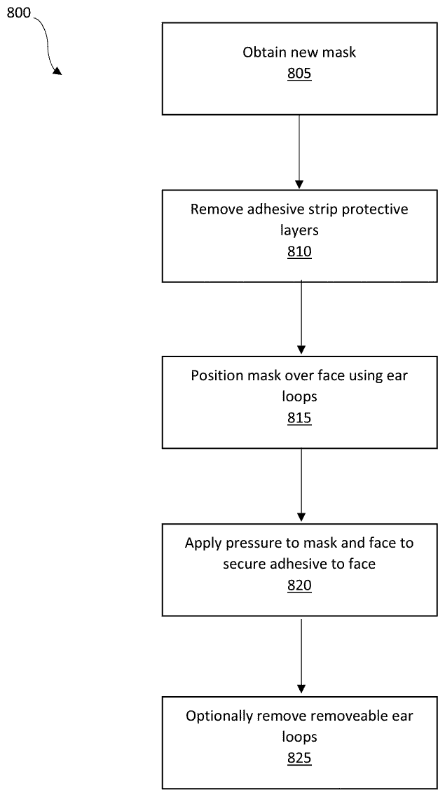

FIG. 8 depicts an exemplary sequence of steps 800 for using a mask with multiple adhesive strips for securing the mask to the wearer's face according to embodiments of the present invention. Using the mask according to steps 800 can help secure and align the mask to the wearer's nose and mouth and help prevent the transmission of viruses and other germs, as well as providing added freedom when the ear loops are optionally removed.

At step 805, a new mask having multiple adhesive strips with removeable protective layers is obtained.

At step 810, the removeable protective layers are removed from the adhesive strips.

At step 815, the mask is positioned over the face and secured around the ears using ear loops.

At step 820, pressure is applied to the mask and face to secure the adhesive to the face.

At step 825, the ear loops are optionally removed from the mask. The mask is advantageously held in place by the adhesive strips for added freedom.

Embodiments of the present invention are thus described. While the present invention has been described in particular embodiments, it should be appreciated that the present invention should not be construed as limited by such embodiments, but rather construed according to the following claims.

What is claimed is:

1. A mask comprising:
an air-permeable layer configured to cover a nose and a mouth of a wearer;
a first adhesive layer disposed on a first lateral edge portion of the air-permeable layer; and
a second adhesive layer disposed on a second lateral edge portion of the air-permeable layer, wherein the first and second adhesive layers are operable to secure the air-permeable layer to a face of a wearer.

2. The mask described in claim 1, further comprising a flexible metal strip disposed on a top edge portion of said air-permeable layer configured to conform the top edge portion of said air-permeable layer to the nose of the wearer to facilitate securing the air-permeable layer to the face.

3. The mask described in claim 1, further comprising removeable ear loops disposed on said first and second lateral edge portions.

4. The mask described in claim 1, further comprising:
a third adhesive layer disposed lower than said first adhesive layer on said first later edge portion of the air-permeable layer; and
a fourth adhesive layer disposed lower than said second adhesive layer on said second lateral edge portion of the air-permeable layer.

5. The mask described in claim 4, wherein said first, second, third, and fourth adhesive layers comprise thin adhesive strips substantially ½ inch in length and ¼ inch in width and further comprise peel-off protective strips.

6. The mask described in claim 1, wherein said first and second adhesive layers are disposed on respective center portions of said first and second lateral edge portions.

7. The mask described in claim 6, wherein said first and second adhesive layers comprise adhesive strips substantially 2 inches in length.

8. A protective mask comprising:
an air-permeable layer configured to cover a nose and a mouth of a wearer;
a pair of ear loops for securing the air-permeable layer around the nose and mouth of the wearer by securing to ears of the wearer;
a first adhesive layer disposed on a first lateral edge portion of the air-permeable layer; and
a second adhesive layer disposed on a second lateral edge portion of the air-permeable layer, wherein the first and second adhesive layers secure the air-permeable layer around the nose and mouth of the wearer in conjunction with the pair of ear loops to substantially prevent breath from flowing out of lateral gaps between said air-permeable layer and the nose and mouth of the wearer.

9. The protective mask described in claim 8, further comprising a flexible thin strip disposed on a top edge portion of said air-permeable layer configured to conform the top edge portion of said air-permeable layer to the nose of the wearer.

10. The protective mask described in claim 8, further comprising:
a third adhesive layer disposed lower than said first adhesive layer on said first later edge portion of the air-permeable layer; and
a fourth adhesive layer disposed lower than said second adhesive layer on said second lateral edge portion of the air-permeable layer.

11. The protective mask described in claim 10, wherein said first, second, third, and fourth adhesive layers comprise thin adhesive strips substantially ½ inch in length and ¼ inch in width and further comprise peel-off protective strips..

12. The protective mask described in claim 8, wherein said first and second adhesive layers are disposed on respective center portions of said first and second lateral edge portions.

13. The protective mask described in claim 12, wherein said first and second adhesive layers comprise adhesive strips substantially 2 inches in length.

14. A mask personal protective equipment (PPE) comprising:
an air-permeable layer configured to cover a nose and a mouth of a wearer;
a pair of removeable ear loops for securing and aligning the air-permeable layer around the nose and mouth of the wearer;
a first adhesive layer disposed on a first lateral edge portion of the air-permeable layer; and
a second adhesive layer disposed on a second lateral edge portion of the air-permeable layer, wherein the first and second adhesive layers secure the air-permeable layer around the nose and mouth of the wearer and the pair of removeable ear loops are operable to be removed after the first and second adhesive layers are applied to face of the wearer.

15. The mask PPE described in claim 14, further comprising a flexible metal strip disposed on a top edge portion of said air-permeable layer configured to conform the top edge portion of said air-permeable layer to the nose of the wearer.

16. The mask PPE described in claim 14, further comprising:
a third adhesive layer disposed lower than said first adhesive layer on said first later edge portion of the air-permeable layer; and
a fourth adhesive layer disposed lower than said second adhesive layer on said second lateral edge portion of the air-permeable layer.

17. The mask PPE described in claim 16, wherein said first, second, third, and fourth adhesive layers comprise thin adhesive strips substantially ½ inch in length and ¼ inch in width and further comprise peel-off protective strips.

18. The mask PPE described in claim 16, wherein said first and second adhesive layers are disposed on respective center portions of said first and second lateral edge portions.

19. The mask PPE described in claim 18, wherein said first and second adhesive layers comprise adhesive strips substantially 2 inches in length.
